(19) United States
(12) Patent Application Publication
(10) Pub. No.: US 2010/0152287 A1
(43) Pub. Date: Jun. 17, 2010

(54) DISPERSIONS CONTAINING IODOPROPARGYL COMPOUNDS

(75) Inventor: Hermann Uhr, Leverkusen (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/600,861

(22) PCT Filed: May 19, 2008
(86) PCT No.: PCT/EP08/56119

§ 371 Date: Nov. 19, 2009

(30) Foreign Application Priority Data
May 24, 2007 (DE) 10 2007 024 208.7

(51) Int. Cl. A01N 47/12; A01P 1/00; A01P 3/00; A01P 7/04; A01P 13/00

(52) U.S. Cl. 514/479; 514/478

(57) ABSTRACT

Aqueous dispersion containing at least one iodopropargyl compound and at least one block and/or black copolymers on an ethylene and/or propylene oxide basis, having a numerically determined mean molecular weight greater than 1000 g/mol.

The invention relates to aqueous dispersions of iodopropargyl compounds and their use as microbicidal agents for protecting industrial materials.

Iodopropargyl compounds are known active substances which are used in particular in material protection for protecting industrial materials, such as adhesives, glues, paper and cardboard, textiles, leather, wood, wood-based materials, paints and plastic articles, cooling lubricants and other materials which may be attacked or decomposed by microorganisms from attack, in particular by fungi. The most well known representative is IPBC (iodopropargyl butylcarbamate). IPBC is commercially available, either in solid form or in various liquid concentrates, which, however, generally contain organic solvents. The demand for formulations with no VOC or little VOC (volatile organic compound) has, however, greatly increased in recent years. Aqueous suspensions are a possibility here. However, IPBC suspensions commercially available to date have a poor shelf-life because, for example owing to crystal formation, they rapidly lead to a sharp increase in viscosity, in combination with substantially poorer processability. During storage, particularly at relatively high temperatures, this can lead to the formation of large crystals, associated with considerable sedimentation or increase in viscosity in some cases.

Attempts have already been made to solve this problem. In this context, for example, EP-A-1 164 850 describes aqueous dispersions which contain iodopropargyl compounds and partly hydrolyzed polyvinyl alcohol and are intended to reduce the crystal growth in formulations.

While, apart from the abovementioned case, it is not possible with most nonionic and ionic surfactants to obtain iodopropargyl-containing suspensions which are stable over relatively long storage times, particularly at elevated temperatures, the solution proposed in EP-A-1164850 also cannot be realized without a considerable increase in viscosity. There was therefore still the desire to solve the problem.

It was surprisingly found that aqueous iodopropargyl-containing suspensions were obtained if they contain at least one block copolymer and/or block copolymers based on ethylene oxide and/or propylene oxide, having a numerically determined average molecular weight greater than 1000 g/mol, in particular greater than 2000 g/mol.

Preferred iodopropargyl compounds are, for example, 3-iodo-2-propynyl propyl-carbamate, 3-iodo-2-propynyl butylcarbamate (IPBC), 3-iodo-2-propynyl m-chloro-phenylcarbamate, 3-iodo-2-propynyl phenylcarbamate, 3-iodo-2-propynyl 2,4,5-tri-chlorophenyl ether, 3-iodo-2-propynyl-4-chlorophenyl formal (IPCF), di(3-iodo-2-propynyl)hexyl dicarbamate, 3-iodo-2-propynyl oxyethanol ethyl carbamate, 3-iodo-2-propynyl oxyethanol phenyl carbamate, 3-iodo-2-propynyl thioxo thio ethyl carbamate, 3-iodo-2-propynyl carbamate (IPC), N-iodopropargyloxycarbonylalanine, N-iodopropargyloxycarbonylalanine ethyl ester, 3-(3-iodopropargyl)benzoxazol-2-one, 3-(3-iodopropargyl)-6-dichlorobenzoxazole-2-one, 4-chlorophenyl-3-iodopropargyl formal, 3-iodo-2-propynyl n-hexylcarbamate and 3-iodo-2-propynyl cyclohexylcarbamate.

3-Iodo-2-propynyl butylcarbamate (IPBC) is very particularly preferred.

Mixtures thereof may also be used.

In the case of the block copolymer and/or block copolymers based on ethylene oxide and/or propylene oxide, the molecular weight is from greater than 1000 to 30 000 mass units. Preferably, the molecular weight is from greater than 2000 to 16 000 mass units and very particularly preferably from 4000 to 14 000 mass units.

The block copolymers are preferably composed of ethylene oxide and propylene oxide units, it being possible for the number of the respective units to vary within a wide range. Independently of one another, from 10 to 500, preferably for 15 to 400, in particular from 20 to 300, units of ethylene oxide or propylene oxide units are present.

These are preferably block copolymers based on ethylene oxide and propylene oxide. These may preferably be compounds of the general formulae I and II.

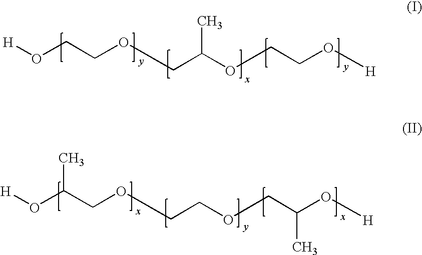

in which
X is the number of propylene oxide units and y is the number of ethylene oxide units.

The block copolymers of the formula (I) contain the more lipophilic propylene oxide units in the center and the ethylene oxide units in the periphery.

The block copolymers of the formula (II) are inverse to (I) and contain the ethylene oxide units in the center and the propylene oxide units in the periphery.

The indices x and y, independently of one another, may vary within a wide range. In general, x and y, independently of one another, are from 10 to 500, preferably from 15 to 400, in particular from 20 to 300, the resulting molecular weight being in the abovementioned general, preferred or particularly preferred ranges.

The block copolymers which can be used according to the invention are known and are commercially available. For example, they are offered by BASF under the trade name “Pluronic®”.

The formulations according to the invention generally contain from 0.5 to 80% by weight, preferably from 1 to 70% by weight, in particular from 1 to 60% by weight, of an iodopropargyl compound and from 0.05 to 20% by weight, preferably from 0.1 to 15% by weight, in particular from 0.5 to 10% by weight, of at least one block copolymer and/or block copolymers based on ethylene oxide and/or propylene oxide, having a numerically determined average molecular weight greater than 1000 g/mol.

Moreover, the formulations optionally also contain further surfactants, auxiliaries and active substances (fungicides, algicides, bactericides and/or insecticides).

All surfactants or mixtures of surfactants which are usually used for the preparation of suspensions can be used as surfactants which can optionally additionally be used. The following may be mentioned here by way of example: nonionogenic and anionic emulsifiers, such as polyoxyethylene fatty acid esters, polyoxyethylene fatty alcohol ethers, alkylaryl polyglycol ethers, alkanesulphonates, alkylsuphates, arylsulphonates and protein hydrolysis products.

All auxiliaries which are also otherwise used in active substance formulations and dispersions can optionally be used as further auxiliaries.

These are, for example, wetting agents, thickeners, antifoams, preservatives and stabilizers.

The wetting agents preferably have a low vapor pressure at room temperature. All wetting agents customarily used in dispersions can be used as wetting agents. Oligo- or polyalkylene glycols or triols, or ethers of the abovementioned compounds, in particular having a molecular weight of less than 1000 g/mol, are preferably used. Very preferred is ethylene glycol, diethylene glycol, triethylene glycol, tetraethylene glycol, polyethylene glycol, propylene glycol, dipropylene glycol, polypropylene glycol, glycerol or mono- or dimethyl, ethyl, propyl or butyl ether of the abovementioned compounds.

The proportion of wetting agents can be varied within a relatively wide range. Preferably, from 1 to 10% by weight, in particular from 2 to 7% by weight, based on the dispersion, are used.

In principle, all substances which build up a three-dimensional structure in water and hence are able to prevent or retard sedimentation can be used as thickeners.

Polysaccharides, xanthan gum, sodium or magnesium silicates, heteropolysaccharides, alginates, carboxymethylcellulose, gum arabic or polyacrylic acids are preferably used. Xanthan gum is very preferably used. The proportion of thickeners in the dispersion according to the invention is preferably from 0.1 to 0.5% by weight, in particular from 0.3 to 0.4% by weight, based on the dispersion.

The dispersions according to the invention preferably have a viscosity at 20° C. of from 50 to 1000 mPa·s, preferably from 100 to 700 mPa·s, in particular from 100 to 600 mPa·s, measured at an applied shear force of 30 s⁻¹.

Preferred dispersions according to the invention are furthermore characterized in that they have a volatile organic content (VOC) of less than 5% by weight, in particular less than 1% by weight. In this context, VOC is understood as meaning compounds having a boiling point of <250° C. at atmospheric pressure.

Otherwise, it is preferable if the dispersions according to the invention contain a proportion of a partly hydrolyzed polyvinyl alcohol of less than 1% by weight, in particular less than 0.5% by weight, based on the dispersion.

Antifoams used are in general surface-active compounds which are only slightly soluble in the surfactant solution. They are preferably antifoams which are derived from natural fats and oils, petroleum derivatives and silicone oils. The proportion of antifoams in the dispersion according to the invention is preferably from 0.01 to 2% by weight, in particular from 0.05 to 1% by weight, based on the dispersion.

The stabilizers which can optionally be used are antioxidants, free radical scavengers or UV absorbers. Optionally, one or more of these substances can be used. The proportion of these auxiliaries in the dispersion according to the invention is preferably from 0.1 to 3% by weight, in particular from 0.5 to 2% by weight, based on the dispersion.

All substances which have an antimicrobial action in the desired sense can be used as fungicides, bactericides, algicides and/or insecticides which are optionally additionally present. Optionally one or more of these substances can be used here.

The optionally present fungicides and bactericides are preferably:

triazoles, such as:

azaconazole, azocyclotin, bitertanol, bromuconazole, cyproconazole, diclobutrazol, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazol, penconazole, propioconazole, prothioconazole, simeoconazole, (±)-cis-1-(4-chlorophenyl)-2-(1H-1,2,4-triazol-1-yl)cycloheptanol, 2-(1-tert-butyl)-1-(2-chlorophenyl)-3-(1,2,4-triazole-1-yl)propan-2-ol, tebuconazole, tetraconazole, triadimefon, triadimenol, triapenthenol, triflumizole, triticonazole, uniconazole and metal salts and acid adducts thereof;

midazoles, such as:

clotrimazole, bifonazole, climbazole, econazole, fenapamil, imazalil, isoconazole, ketoconazole, lombazole, miconazole, perfurazoate, prochloraz, triflumizole, thiazolcar, 1-imidazolyl-1-(4′-chlorophenoxy)-3,3-dimethylbutan-2-one and the metal salts and acid adducts thereof;

pyridines and pyrimidines, such as:

ancymidol, buthiobate, fenarimol, mepanipyrin, nuarimol, pyroxyfur, triamirol;

succinate dehydrogenase inhibitors, such as:

benodanil, carboxim, carboxim sulfoxide, cyclafluramid, fenfuram, flutanil, furcarbanil, furmecyclox, mebenil, mepronil, methfuroxam, metsulfovax, nicobifen, pyrocarbolide, oxycarboxin, shirlan, seedvax;

naphthalene derivatives, such as:

terbinafin, naftifin, butenafin, 3-chloro-7-(2-aza-2,7,7-trimethyloct-3-en-5-yne);

sulfenamides, such as:

dichlorfluanid, tolylfluanid, folpet, fluorfolpet; captan, captofol;

benzimidazoles, such as:

carbendazim, benomyl, fuberidazole, thiabendazole or salts thereof;

morpholine derivatives, such as:

aldimorph, dimethomorph, dodemorph, falimorph, fenpropidin, fenpropimorph, tridemorph, trimorphamide and their salts with arylsulfonic acids, such as, for example, p-toluenesulfonic acid and p-dodecylphenylsulfonic acid;

benzothiazoles, such as: 2-mercaptobenzothiazole;

benzothiophene dioxides, such as: benzo[b]thiophene S,S-dioxide carboxylic acid cyclohexylamide;

benzamides, such as: 2,6-dichloro-N-(4-trifluoromethylbenzyl)benzamide, tecloftalam;

boron compounds, such as: boric acid, boric acid esters, borax;

formaldehyde and formaldehyde-eliminating compounds, such as:

benzyl alcohol mono(poly)hemiformal, 1,3-bis(hydroxymethyl)-5,5-dimethyl-imidazolidine-2,4-diones (DMDMH), bisoxazolidines, n-butanol hemiformal, cis-1-(3-chloroallyl)-3,5,7-triaza-1-azoniaadamantane chloride, 1-[1,3-bis(hydroxymethyl-2,5-dioxoimidazolidin-4-yl]-1,3-bis(hydroxymethyl)urea, dazomet, dimethylolurea, 4,4-dimethyloxazolidine, ethylene glycol hemiformal, 7-ethylbicyclooxazolidine, hexahydro-S-triazine, hexamethylenetetramine, N-hydroxymethyl-N′-methylthiourea, methylenebismorpholine, sodium N-(hydroxymethyl)glycinate, N-methylolchloroacetamide, oxazolidines, paraformaldehyde, tauroline, tetrahydro-1,3-oxazine, N-(2-hydroxypropyl)aminemethanol, tetramethylolacetylenediurea (TMAD);

isothiazolinones, such as:

N-methyliso hiazolin-3-one, 5-chloro-N-methylisothiazolin-3-one, 4,5-dichloro-N-octylisothiazolin-3-one, 5-chloro-N-octylisothiazolinone, N-octylisothiazolin-3-one, 4,5-trimethyleneisothiazolinone, 4,5-benzisothiazolinone;

aldehydes, such as:

cinnamaldehyde, formaldehyde, glutaraldehyde, β-bromocinnamaldehyde, o-phthalaldehyde;

thiocyanates, such as: thiocyanatomethylthiobenzothiazole, methylene bisthiocyanate;

quaternary ammonium compounds and guanidines, such as:

benzalkonium chloride, benzyldimethyltetradecylammonium chloride, benzyl-dimethyldodecylammonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminoctadine tris(albesilate);

phenols, such as:

tribromophenol, tetrachlorophenol, 3-methyl-4-chlorophenol, 3,5-dimethyl-4-chloro-phenol, dichlorophen, 2-benzyl-4-chlorophenol, triclosan, diclosan, hexachlorophene, methyl p-hydroxybenzoate, ethyl p-hydroxybenzoate, propyl p-hydroxybenzoate, butyl p-hydroxybenzoate, octyl p-hydroxybenzoate, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethylphenoxy)phenol and the alkali metal and alkaline earth metal salts thereof;

microbicides having an activated halogen group, such as:

bronidox, 2-bromo-2-nitro-1,3-propanediol, 2-bromo-4′-hydroxyacetophenone, 1-bromo-3-chloro-4,4,5,5-tetramethyl-2-imidazolidinone, β-bromo-β-nitrostyrene, chloracetamide, chloramine T, 1,3-dibromo-4,4,5,5-tetramethyl-2-imidazolidinone, dichloramine T, 3,4-dichloro-(3H)-1,2-dithiol-3-one, 2,2-dibromo-3-nitrilepropionamide, 1,2-dibromo-2,4-dicyanobutane, halane, halazone, mucochloric acid, phenyl(2-chlorocyanovinyl)sulfone, phenyl(1,2-dichloro-2-cyanovinyl)sulfone, trichloroisocyanuric acid;

pyridines, such as:

1-hydroxy-2-pyridinethione (and its Cu, Na, Fe, Mn, Zn salts), tetrachloro-4-methyl-sulfonylpyridine, pyrimethanol, mepanipyrim, dipyrithion, 1-hydroxy-4-methyl-6-(2,4,4-trimethylpentyl)-2(1H)-pyridine;

methoxyacrylates or the like, such as:

azoxystrobin, dimoxystrobin, fluoxastrobin, kresoxim-methyl, metominostrobin, orysastrobin, picoxystrobin, pyraclostrobin, trifloxystrobin, 2,4-dihydro-5-methoxy-2-methyl-4-[2[[[[1-[3-(trifluoromethyl)phenyl]ethylidene]amino]oxy]methyl]phenyl]-3H-1,2,4-triazol-3-one (CAS No. 185336-79-2);

metal salts, such as:

salts of the metals tin, copper and zinc with higher fatty acids, resin acids, naphthenic acids and phosphoric acid, such as, for example, tin, copper, zinc naphthenate, zinc octanoate, zinc 2-ethylhexanoate, zinc oleate, zinc phosphate, zinc benzoate;

metal salts, such as:

salts of the metals tin, copper, zinc and also chromates and dichromates, such as, for example, copper hydroxycarbonate, sodium dichromate, potassium dichromate, potassium chromate, copper sulfate, copper chloride, copper borate, zinc fluorosilicate, copper fluorosilicate;

oxides, such as: oxides of the metals tin, copper and zinc, such as, for example, tributyltin oxide, Cu₂O, CuO, ZnO;

oxidizing agents, such as: hydrogen peroxide, peracetic acid, potassium persulfate;

dithiocarbamates, such as:

cufraneb, ferban, potassium N-hydroxymethyl-N′-methyldithiocarbamate, Na or K dimethyldithiocarbamate, macozeb, maneb, metam, metiram, thiram, zineb, ziram;

nitriles, such as: 2,4,5,6-tetrachloroisophthalodinitrile, disodium cyanodithioimido-carbamate;

quinolines, such as: 8-hydroxyquinoline and the Cu salts thereof;

other fungicides and bactericides, such as:

bethoxazin, 5-hydroxy-2(5H)-furanone; 4,5-benzdithiazolinone, 4,5-trimethylene-dithiazolinone, N-(2-p-chlorobenzoylethyl)hexaminium chloride, 2-oxo-2-(4-hydroxyphenyl)acethydroximic acid chloride, tris-N-(cyclohexyldiazenium-dioxy)aluminum, N-(cyclohexyldiazeniumdioxy)tributyltin or K salts, bis-N-(cyclo-hexyldiazeniumdioxy)copper, iprovalicarb, fenhexamide, spiroxamine, carpropamide, diflumetorin, quinoxyfen, famoxadone, polyoxorim, acibenzolar-S-methyl, furametpyr, thifluzamide, methalaxyl-M, benthiavalicarb, metrafenone, cyflufenamide, tiadinil, tea tree oil, phenoxyethanol,

Ag, Zn or Cu-containing zeolites, alone or enclosed in polymeric active substances.

The fungicides and bactericides are very particularly preferably:

azaconazole, bromuconazole, cyproconazole, dichlobutrazole, diniconazole, hexaconazole, metaconazole, penconazole, propiconazole, tebuconazole, dichlofluanid, tolylfluanid, triadimefon, fluorfolpet, methfuroxam, carboxin, benzo[b]thiophene S,S-dioxide carboxylic acid cyclohexylamide, fenpiclonil, 4-(2,2-difluoro-1,3-benzodioxol-4-yl)-1H-pyrrol-3-carbonitrile, butenafin, imazalil, N-methylisothiazolin-3-one, 5-chloro-N-methylisothiazolin-3-one, N-octylisothiazolin-3-one, dichloro-N-octylisothiazolinone, mercaptobenzothiazole, thiocyanatomethylthiobenzothiazole, thiabendazole, benzoisothiazolinone, N-(2-hydroxypropyl)aminomethanol, benzyl alcohol (hemi)formal, N-methylolchloroacetamide, N-(2-hydroxypropyl)aminemethanol, glutaraldehyde, omadine, Zn-omadine, dimethyl dicarbonate, 2-bromo-2-nitro-1,3-propanediol, bethoxazin, o-phthalaldehyde, 2,2-dibromo-3-nitrilepropionamide, 1,2-dibromo-2,4-dicyanobutane, 1,3-bis(hydroxymethyl)-5,5-dimethylimidazolidine-2,4-dione (DMDMH), tetramethylolacetylenediurea (TMAD), ethylene glycol hemiformal, p-hydroxybenzoic acid, carbendazim, chlorophene, 3-methyl-4-chlorophenol, o-phenylphenol.

The algicides are preferably:

acetochlor, acifluorfen, aclonifen, acrolein, alachlor, alloxydim, ametryn, amidosulfuron, amitrole, ammonium sulfamate, anilofos, asulam, atrazine, azafenidin, aziptrotryn, azimsulfuron,

benazolin, benfluralin, benfuresate, bensulfuron, bensulfide, bentazone, benzofencap, benzthiazuron, bifenox, bispyribac, bispyribac-sodium, borax, bromacil, bromobutide, bromofenoxim, bromoxynil, butachlor, butamifos, butraline, butylate, bialaphos, benzoyl-prop, bromobutide, butroxydim,

carbetamide, carfentrazone-ethyl, carfenstrol, chlomethoxyfen, chloramben, chlorbromuron, chlorflurenol, chloridazone, chlorimuron, chlornitrofen, chloracetic acid, chloransulam-methyl, cinidon-ethyl, chlorotoluron, chloroxuron, chlorpropham, chlorsulfuron, chlorthal, chlorthiamide, cinmethyline, cinofulsuron, clefoxydim, clethodim, clomazone, chlomeprop, clopyralid, cyanamide, cyanazine, cycloate, cycloxydim, chloroxynil, chlodinafop-propargyl, cumyluron, clometoxyfen, cyhalofop, cyhalofop-butyl, clopyrasulfuron, cyclosulfamuron,

diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamide, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamide, dithiopyr, dimethametryn,

eglinazin, endothal, EPTC, esprocarb, ethalfluralin, ethidimuron, ethofumesate, ethobenzanid, ethoxyfen, ethametsulfuron, ethoxysulfuron,

fenoxaprop, fenoxaprop-P, fenuron, flamprop, flamprop-M, flazasulfuron, fluazifop, fluazifop-P, fuenachlor, fluchloralin, flufenacet flumeturon, fluorocglycofen, fluoronitrofen, flupropanate, flurenol, fluridone, flurochloridone, fluroxypyr, fomesafen, fosamine, fosametine, flamprop-isopropyl, flamprop-isopropyl-L, flufenpyr, flumiclorac-pentyl, flumipropyn, flumioxzim, flurtamon, flumioxzim, flupyrsulfuron-methyl, fluthiacet-methyl,

glyphosate, glufosinate-ammonium,

haloxyfop, hexazinone,

imazamethabenz, isoproturon, isoxaben, isoxapyrifop, imazapyr, imazaquin, imazethapyr, ioxynil, isopropalin, imazosulfuron, imazomox, isoxaflutole, imazapic,

ketospiradox,

lactofen, lenacil, linuron,

MCPA, MCPA-hydrazide, MCPA-thioethyl, MCPB, mecoprop, mecoprop-P, mefenacet, mefluidide, mesosulfuron, metam, metamifop, metamitron, metazachlor, methabenzthiazuron, methazole, methoroptryne, methyldymron, methylisothiocyanate, metobromuron, metoxuron, metribuzin, metsulfuron, molinate, monalid, monolinuron, MSMA, metolachlor, metosulam, metobenzuron,

naproanilide, napropamide, naptalam, neburon, nicosulfuron, norflurazon, sodium chlorate,

oxadiazone, oxyfluorfen, oxysulfuron, orbencarb, oryzalin, oxadiargyl,

propyzamide, prosulfocarb, pyrazolate, pyrazolsulfuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulfuron, prodiamine, profoxydim, prometryn, propachlor, propanil, propaquizafob, propazine, propham, propisochlor, pyriminobac-methyl, pelargonic acid, pyrithiobac, pyraflufen-ethyl,

quinmerac, quinocloamine, quizalofop, quizalofop-P, quinchlorac,

rimsulfuron,

sethoxydim, sifuron, simazine, simetryn, sulfosulfuron, sulfometuron, sulfentrazone, sulcotrione, sulfosate,

tar oils, TCA, TCA sodium, tebutam, tebuthiuron, terbacil, terbumeton, terbutylazine, terbutryn, thiazafluoron, thifensulfuron, thiobencarb, thiocarbazil, tralkoxydim, triallate, triasulfuron, tribenuron, triclopyr, tridiphane, trietazine, trifluralin, tycor, thiadiazimin, thiazopyr, triflusulfuron,

vernolate.

The algicides are very particularly preferably triazine compounds, such as, for example, terbutryn, cybutryn, propazine or terbuton, urea compounds, such as, for example, diuron, benzthiazuron, methabenzthiazuron, tebuthiuron and isoproturon, or uracils, such as, for example, terbacil.

In general, the ratio of iodopropargyl compound to the optionally additional active substances is from 50:1 to 1:50, preferably from 20:1 to 1:20, in particular from 10:1 to 1:10.

If the dispersions are to contain no bactericide as an additional active substance, it is advantageous to protect them from attack by bacteria. This is achieved by adding one or more of the abovementioned bactericidal active substances. The amount of the bactericides only for stabilizing the dispersion is in general from 0.0005 to 2% by weight, preferably from 0.001 to 1% by weight, in particular from 0.005 to 0.5% by weight, based on the total dispersion.

In addition to IPBC and the block copolymer and/or block copolymers described above, preferred dispersions contain thickeners, preferably those from the class consisting of the polysaccharides, such as xanthan gum, and preferably wetting agents, such as, for example, polyethylene glycol, triethylene glycol or tetraethylene glycol. In addition, the preferred dispersion optionally acquires nonionogenic and anionic emulsifiers, such as polyoxyethylene fatty acid esters, polyoxyethylene fatty alcohol ethers, alkylaryl polyglycol ethers, alkanesulfonates, alkylsulfates, arylsulfonates, optionally antifoams which are derived from silicone oil or mineral oil, if necessary bactericidal preservatives, optionally stabilizers from the class consisting of the oxidation inhibitors, free radical scavengers and UV absorbers and, as additional active substances, fungicides, such as, for example, octylisothiazolinone, dichlorooctylisothiazolinone, Zn-omadine, thiabendazole, bethoxazine, propiconazole, tebuconazole, triadimefon, carbendazim, chlorthalonil, imazalil, mercaptobenzothiazole, and/or algicides, such as terbutryn, cybutryn, isoproturon, diuron.

The invention furthermore relates to the use of the dispersions according to the invention as microbicidal compositions for protecting industrial materials. Suitable industrial materials are in particular adhesives, glues, paper, cardboard, leather, wood, wood-based materials, wood-plastic composites, paints, cooling lubricants and heat-transfer liquids. Paint, wood and wood-based materials are very particularly preferred.

The invention also relates to a process for protecting industrial materials from attack and/or destruction by microorganisms, which is characterized in that the dispersion according to the invention is allowed to act on the microorganism or the habitat thereof. The amount of the dispersion according to the invention which is used depends on the type and the occurrence of the microorganisms to be controlled and on the composition of the material to be protected. The optimum amount used can be determined by test series. In general, from 0.001 to 5% by weight of the dispersion according to the invention, preferably from 0.05 to 2.0% by weight, based on the material to be protected, are used.

### EXAMPLES

General method for the preparation of the dispersions mentioned in table 1:

The water is initially introduced and the stated amount of formulation auxiliary/surfactant and antifoam is added with stirring. Thereafter, the stated amount of iodopropargyl compound and optionally further active substances are added and stirring is effected for about 30 minutes with simultaneous use of a toothed dissolver (650 rpm) and of an Ultraturrax (13 000 rpm) until the predispersion is homogeneous.

This predispersion is then milled once by means of a bead mill (glass beads from 1.0 to 1.2 mm diameter), the milling temperature being kept below 40° C. Thereafter, the optionally a certain amount of a 3% strength aqueous xanthan gum solution and optionally further preservative (Preventol D6 corresponds to an aqueous solution of 0.7% of isothiazolinones and about 23% of O-formal) are added and stirring is effected with a paddle stirrer until the dispersion is homogeneous. The viscosity was determined using a rotary viscometer and the stated viscosity is based on a shear force of 30 l/s.

The dispersions obtained were stored at room temperature and 40° C. and the redispersibility by stirring and the viscosity were tested at regular intervals.

TABLE 1
(Examples)

| | Example 1 | Example 2 | Example 3 | Example 4 |
|---|---|---|---|---|
| IPBC [%] | 50 | 40 | 10 | 5 |
| Further active | — | — | 20% of diuron | 20% of diuron |
| substances | | | | 5% of n-octyliso- |
| | | | | thiazolinone |
| Formulation | 5% of Pluronic | 2% of Pluronic | 3% of Pluronic | 1.5% of Pluronic |
| auxiliaries | F 127 | F 127 2% of | F 127 | F 127 2.25% of |
| | | triethylene glycol | | Soprophor S 25 |
| | | | | 5% of PEG 300 |
| Antifoam SRE [%] | 0.2 | 0.2 | 0.2 | 0.2 |
| 3% strength thickener | 2 | 2 | 5 | 7.4 |
| solution [%] | | | | |
| Preventol D 6 [%] | 0.1 | 0.1 | 0.1 | 0.1 |
| Water [%] | | | | |

Viscosities at 30 l/s

| | | | | |
|---|---|---|---|---|
| Start | 402 mPas | 247 mPas | 140 mPas | 365 mPas |
| 1 month; RT | 450 mPas | 271 mPas | 125 mPas | |
| 1 month; 40° C. | 327 mPas | 264 mPas | 122 mPas | |
| 6 months; RT | 346 mPas | 246 mPas | 122 mPas | |
| 1 year; RT | 359 mPas | 273 mPas | — | |

| | | Comparison analogous |
|---|---|---|
| | Example 5 | to EP 1164850 |
| IPBC [%] | 2 | 50 |
| Further active | 12% of diuron | |
| substances | 5% of thiabendazole | |
| Formulation | 0.95% of Pluronic F 127 | 10% of Mowiol 26-88 |
| auxiliaries | 0.95% of Soprophor S 25 | (partly hydrolyzed |
| | 4% of PEG 300 | polyvinyl acetate) |
| Antifoam SRE [%] | 0.22 | 0.2 |
| 3% strength thickener | 13 | — |
| solution [%] | | |
| Preventol D 6 [%] | 0.1 | — |
| Water [%] | | |
| Start | 286 mPas | Experiment was already |
| | | solid in the mill and could |
| | | no longer be measured. |
| 1 month; RT | 296 mPas | — |
| 1 month; 40° C. | 296 mPas | — |
| 6 months; RT | | — |
| 1 year; RT | | — |

Pluronic F 127 = copolymer of ethylene oxide and propylene oxide, average MW about 12 600 g/mol
Soprophor S 25 = polyethoxypolyaryl phenyl ether (7-8 EO units)

What is claimed is:

1. An aqueous dispersion containing at least one iodopropargyl compound and at least one block copolymer and/or block copolymers based on ethylene oxide and/or propylene oxide, having a numerically determined average molecular weight greater than 1000 g/mol, in particular greater than 2000 g/mol.

2. The dispersion as claimed in claim 1, characterized in that at least one block copolymer based on ethylene oxide and propylene oxide is used as the block copolymer and/or block copolymers.

3. The dispersion as claimed in claim 1, characterized in that it has a viscosity at 20° C. of from 50 to 1000 mPa·s, preferably 100 to 700 mPa·s, in particular from 100 to 600 mPa·s, measured at an applied shear force of 30 s⁻¹.

4. The dispersion as claimed in claim 1, characterized in that it has a volatile organic content (VOC) of less than 5% by weight, in particular less than 1% by weight.

5. The dispersion as claimed in claim 1, characterized in that it contains a proportion of partly hydrolyzed polyvinyl alcohol of less than 1% by weight, in particular less than 0.5% by weight, based on the dispersion.

6. The dispersion as claimed in claim 1, characterized in that it contains
from 0.5 to 80% by weight, preferably from 1 to 70% by weight, in particular from 1 to 60% by weight, of an an iodopropargyl compound and
from 0.05 to 20% by weight, preferably from 0.1 to 15% by weight, in particular from 0.5 to 10% by weight, of at least one block copolymer and/or block copolymers based on ethylene oxide and/or propylene oxide, having a numerically determined average molecular weight greater than 1000 g/mol, in particular greater than 2000 g/mol.

7. The dispersion as claimed in claim 1, characterized in that at least 3-iodo-2-propynyl butylcarbamate (IPBC) is used as the iodopropargyl compound.

8. The dispersion as claimed in claim 1, characterized in that it additionally contains a thickener.

9. The dispersion as claimed in claim 1, characterized in that it contains at least one further antimicrobially active compound from the series consisting of the fungicides, bactericides, herbicides and/or insecticides.

10. The use of a dispersion as claimed in claim 1 as a microbicidal composition for protecting industrial materials.

11. The use as claimed in claim 10, characterized in that the industrial materials are adhesives, glues, paper, cardboard, leather, wood, wood-based materials, wood-plastic composites, paints, cooling lubricants and heat-transfer liquids.

12. A process for protecting industrial materials from attack and/or destruction by microorganisms, characterized in that at least one dispersion as claimed in claim 1 is allowed to act on the microorganism or its habitat.
